(19) United States
(12) Patent Application Publication
(10) Pub. No.: US 2017/0041133 A1
(43) Pub. Date: Feb. 9, 2017

(54) ENCRYPTION METHOD, PROGRAM, AND SYSTEM

(71) Applicant: Ichiro KAZAWA, Tokyo (JP)

(72) Inventor: Ichiro KAZAWA, Tokyo (JP)

(21) Appl. No.: 15/304,465

(22) PCT Filed: Feb. 26, 2015
(86) PCT No.: PCT/JP2015/055603

§ 371 Date: Oct. 14, 2016

(30) Foreign Application Priority Data
Apr. 28, 2014 (JP) 2014-092261

(51) Int. Cl. H04L 9/06

(52) U.S. Cl. CPC H04L 9/065

(57) ABSTRACT

[Problem] To provide, combining a conventional encryption scheme, an encryption that is excellent in coding ratio, suitable for stream encryption and safe against known plain text attacks. [Solution] From a random number sequence array consisting of random number sequences having no mutual correlations and having different lengths, a random number sequence is selected by using, as an index, a random number that is independently generated by means of a physical random number or the like. A plain text to be encrypted is then obfuscated on the basis of the selected random number sequence, further concatenated to the random number and thereafter subjected to application of a conventional type of encryption algorithm.

### TECHNICAL FIELD

The present invention relates to a computer-executed method for encryption, especially those that are safe against known-plaintext attacks.

### BACKGROUND ART

Encryption technology is very important in today's information technologies. It is required for encryption technology to be safe against various types of attacks; it should not be possible to decipher an encrypted text in reasonable time without knowing its encryption key.

One type of attacks is known-plaintext attack (KPA). It is an effective attack where the ciphertexts corresponding to known plain texts can be obtained. When the beginning of the plaintext is fixed data, a sequence number or a time stamp (e.g. in order to comply with communication protocol standards), it is easier to infer the plaintext corresponding to the ciphertext. Therefore, safety against KPA is an important requirement for encryption methods.

Just increasing the encryption key size can be problematic in terms of technology standard compliance and computational complexity. It is preferable to be safe against KPA, while complying with standard encryption specifications.

Coding rate also needs to be good, meaning that a ciphertext should not be significantly larger than the corresponding plain text.

Moreover, in today's information technology environment, an encryption method should be usable not only to block encryption, but also to stream encryption in order to encrypt variable-length data such as digitalized phone voices.

It is possible to pre-process a plain text using secret information which is not dependent on the plain text, the initialization vector and the encryption key in order to increase computational complexity for a KPA using multiple plaintext/ciphertext pairs.

For example, in US20030191950, a method to preprocess a plaintext using secret information based on all the bits in the plaintext is disclosed. However, this method has an issue when applied to stream encryption, because the whole plaintext must be cached to be scanned twice, increasing the required memory space significantly.

### SUMMARY OF INVENTION

### Problems to be Solved by the Invention

To provide encryption method, system and program which have a good coding rate, are suitable for streaming encryption and are safe against known plaintext attacks.

### Means for Solving the Problems

The present invention solves the above problem by providing a method for encrypting a text comprising: generating a random number, selecting, based on the random number, a random number sequence from a set of independent random number sequences with mutually different length, transforming, based on the selected random number sequence, a first plaintext using a first transformation method, concatenating the random number the transformed first plaintext into a second plaintext, and transforming the second plaintext using a second transformation method.

And the present invention solves the above problem by providing a method for encrypting a text according to the previous paragraph wherein: the first transformation method comprises: repeating the selected random number sequence, and applying exclusive-OR operation on the repeated selected random number sequence and the first plaintext.

And the present invention solves the above problem by providing a computer program for encrypting a text comprising computer-executable instructions for: generating a random number, selecting, based on the random number, a random number sequence from a set of independent random number sequences with mutually different length, transforming, based on the selected random number sequence, a first plaintext using first transformation instructions, concatenating the random number the transformed first plaintext into a second plaintext, and transforming the second plaintext using second transformation instructions.

And the present invention solves the above problem by providing a computer program for encrypting a text according to the previous paragraph wherein: the first transformation method comprises: repeating the selected random number sequence, and applying exclusive-OR operation on the repeated selected random number sequence and the first plaintext.

And the present invention solves the above problem by providing a computer system for encrypting a text comprising instructions for: a generator of a random number, a selector selecting, based on the random number, a random number sequence from a set of independent random number sequences with mutually different length, a first transformer, based on the selected random number sequence, transforming a first plaintext using a first transformation method, a concatenater concatenating the random number the transformed first plaintext into a second plaintext, and a second transformer, transforming the second plaintext using a second transformation method.

A computer system for encrypting a text according to the previous paragraph wherein: the first transformer further comprises: a third transformer, repeating the selected random number sequence, and a fourth transformer, applying exclusive-OR operation on the repeated selected random number sequence and the first plaintext.

### Advantageous Effect of the Invention

An encryption method, system and program which have a good coding rate, combined with conventional encryption methods, are suitable for streaming encryption and are safe against known plaintext attacks are provided.

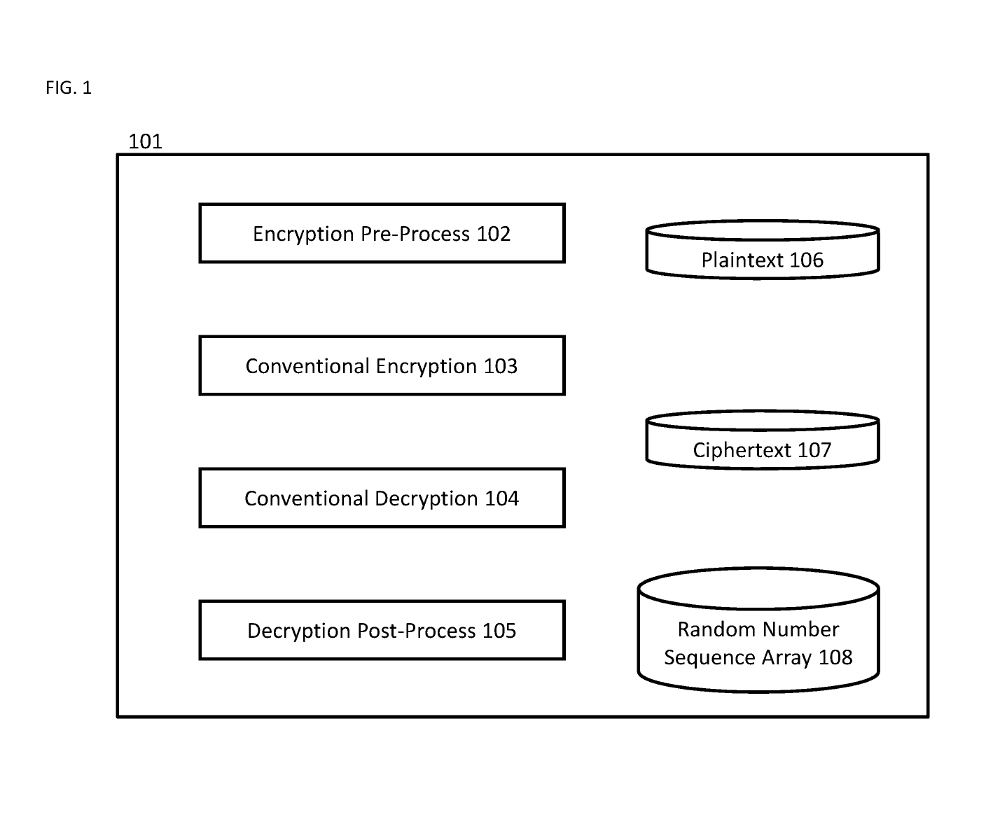

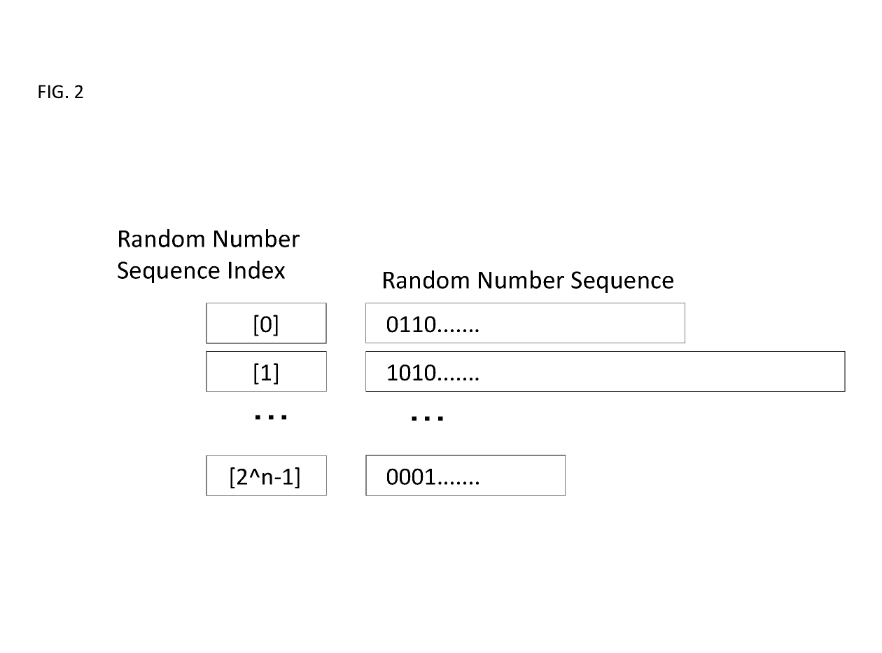

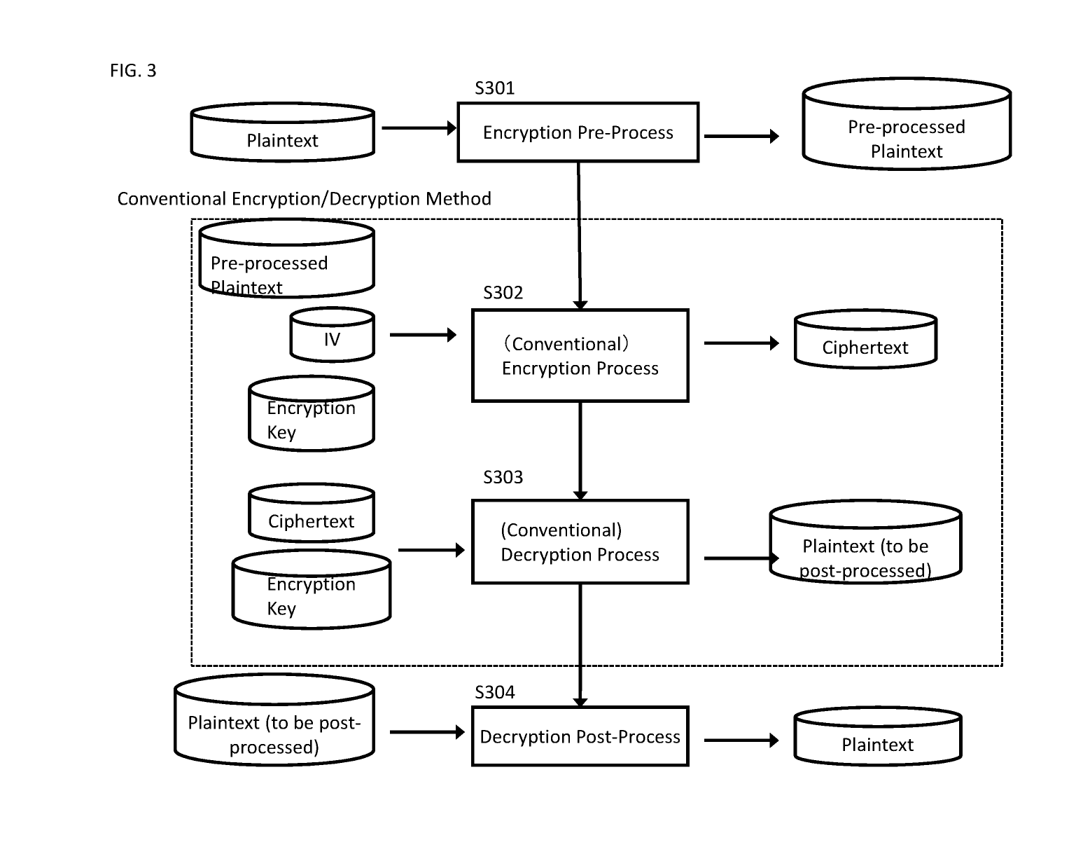

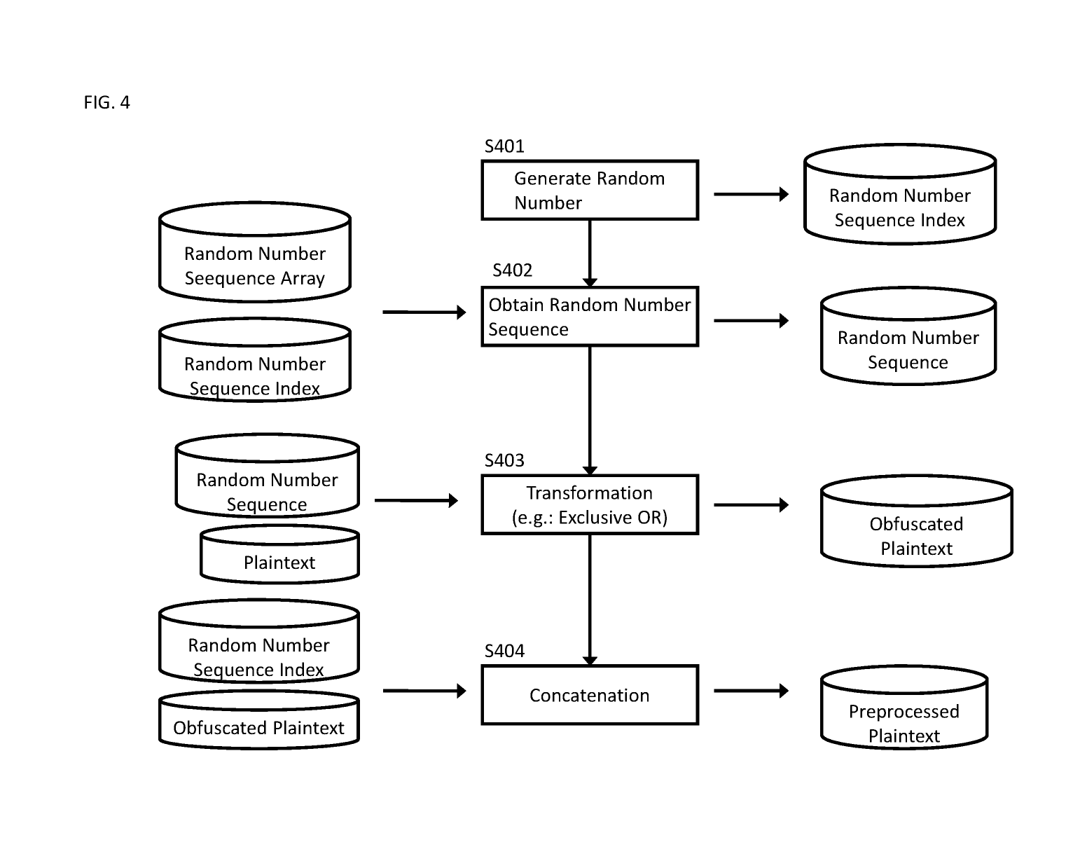

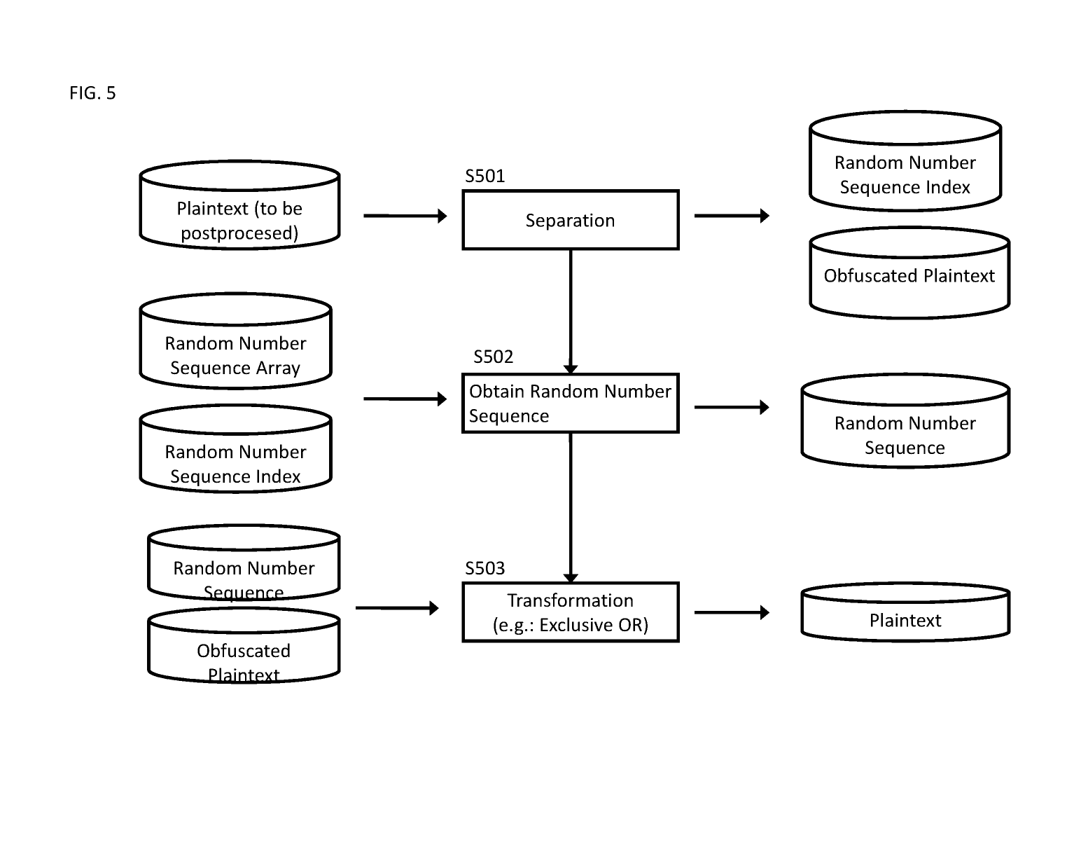

### BRIEF DESCRIPTION OF DRAWINGS

[FIG. 1] This is an overview picture of an exemplary information system used in one embodiment of the present invention.

[FIG. 2] This is an exemplary a random number sequence array used in one embodiment of the present invention.

[FIG. 3] This is an exemplary overview flow chart of encryption and decryption processes in one embodiment of the present invention.

[FIG. 4] This is an exemplary overview flow chart of encryption pre-process in one embodiment of the present invention.

[FIG. 5] This is an exemplary overview flow chart of decryption post-process one embodiment of in the present invention.

### DESCRIPTION OF EMBODIMENTS

Hereafter, one embodiment of the present invention will be explained, referring to the figures.

FIG. 1 is a functional overview of an exemplary Information System 101 used in one embodiment of the present invention. Information System 101 can consist of physical computing machines or virtual computing resources provided by, for example, a cloud infrastructure service.

Encryption Pre-Process 102 is a function to transform plaintexts before Conventional Encryption 103. Its detail is shown in FIG. 4 and described later.

Conventional Encryption 103 is a function to perform encryption (transforming plaintexts to ciphertexts) using a well-known encryption method such as Data Encryption Standard (DES). It is well-known and self-explanatory, so it will not be discussed any further.

Conventional Decryption 104 is a function to perform decryption (transforming ciphertexts to plaintexts) using a well-known method such as Data Encryption Standard (DES). It is well-known and self-explanatory, so it will not be discussed any further.

Decryption Post-Process 105 is a function to transform plaintext after Conventional Decryption 105. Its detail is shown in FIG. 5 and described later.

Plaintext 106 is input data to a decryption process and output data from an encryption process in the present invention. It may be stored in a non-volatile storage such as hard disk drives or a temporary storage in main memories. It may be provided from outside of Information System 101 in the present invention.

Ciphertext 107 is output data from a decryption process and input data to an encryption process in the present invention. It may be stored in a non-volatile storage such as hard disk drives or a temporary storage in main memories. It may be provided to outside systems from Information System 101 in the present invention.

Random Number Sequence Array 108 is a mean that stores random number sequences that are used as a parameter used by Encryption Pre-Process 102 and Decryption Post-Process 105. It may be stored in a non-volatile storage or a temporary storage in main memories. It may be provided from outside of Information System 101 in the present invention. Random Number Sequence Array 108 is detailed in FIG. 2 and is described later.

FIG. 2 is an example of Random Number Sequence Array 108 in one embodiment in the present invention. It is a set of 2̂n (2 powered by n, where n is a natural number) random numbers determined as a pre-determined specification. This specification may be an open standard accessible by anyone, or one that communicating parties can exchange before performing communication. One can specify one random number in Random Number Sequence Array 108 by specifying an index number. Preferably, the lengths of each random number in Random Number Sequence Array 108 are different and are mutually prime, because if the length is fixed, randomness effect could be compromised.

FIG. 3 is an exemplary overview flow chart of encryption and decryption processes in the present invention. Each process step is depicted as a rectangular in the middle and input to each step is shown in its left, and output from each step is shown in its right. The encryption process in the present invention combines Encryption Preprocess (S301) and Conventional Encryption (S302) (for example, DES). The decryption process in the present invention combines Decryption Postprocess (S301) and Conventional Decryption (S302) (for example, DES).

FIG. 4 is an exemplary overview flow chart of encryption pre-process in the present invention. Each step will be explained below.

### (S401)

One n-bit random number is determined, independent of information such as the plaintext itself, the initialization vector, the encryption key or the time of day. Therefore, this random number is determined purely randomly, making a probability of an accidental match to be 2̂-n (an inverse of 2 powered by n). This random number can be generated by a physical random number generator. This random number is temporarily saved as a random number sequence index.

### (S402)

Using the random number sequence index in S401, a random number sequence is obtained from Random Number Sequence Array 108 and saved temporarily.

### (S403)

Using the S402 random number sequence, the plaintext is transformed into an obfuscated plaintext. Preferably, this transformation should be easy to inverse-transform and should not increase the data size. For example, by repeating Random Number Sequence to match the length of the plaintext and applying XOR (exclusive OR) operation, these two conditions can be met.

### (S404)

By concatenating the obfuscated plaintext in S403 and the random number index, a preprocessed plaintext can be obtained, which is an input data to Conventional Encryption Step (S302). Here “concatenating” includes concatenating the random number index in front of the obfuscated plaintext, concatenating the random number index at the end of the obfuscated plaintext, or embedding the random number index into a pre-determined position of the obfuscated plaintext. Though the preprocessed plaintext is slightly larger than the original plaintext, the size difference is limited to a bit width of the random number sequence index, not affecting coding ratio significantly.

FIG. 5 is an exemplary overview flow chart of decryption post-process 304 in the present invention. Each process step will be explained below.

### (S501)

The output from a conventional decryption method such as DES is separated into the random number sequence index and the obfuscated plaintext. Since the length and the position of the random number sequence index is known as the agreed-on specification, this process is straightforward.

### (S502)

Using the random number sequence index in S501, the random sequence number is obtained from Random Number Sequence Array 108 and saved temporarily.

### (S503)

Using the random number sequence in S502, the obfuscated plaintext is transformed into the plaintext. This transformation is inverse to the process in S403. For example, if XOR operations were performed with the random number sequence repeated as necessary, the inverse process in S503 will be the same operation.

### Proof of Safety of an Encryption Method in the Present Invention

In the following paragraphs, safety of an encryption method in the present invention will be explained.

The random number sequence index is generated from an independent source in the system. Its secrecy is ensured by encryption. One cannot assume or enforce which random number sequence index to be used. In the following explanation, n is a bit width of random number sequence index, m is the number of plaintext/ciphertext pairs required in KPA, and L is a bit width of the key used in encryption.

Even if a KPA attacker has more than one plaintext/ciphertext pairs, each pair is associated with an independent random number sequence index. Therefore, it requires (2̂n)̂m=2̂(n*m) trials in KPA. On the other hand, a brute force attack requires 2̂L trials.

In the brute force attack, each trial requires only one decrypting and matching process. On the other hand, in KPA, each trial requires additional process of finding the key using a plaintext/ciphertext pair. Therefore, letting T1 be a time for one trial in the brute force attack, and letting T2 be a time for one trial in KPA, T2 is greater than or equal to T1 (T2>=T1).

If KPA can find a key faster than the brute force attack, that KPA can be said to be successful. Because total computation equals to the number of trials times the number of trial, the condition T1*2̂L>T2*2̂(n*m) has to be met, for KPA to be successful

Since T1<=T2, T1*2̂L>T2*2̂(n*m) can be deformed as the following.

T1*2̂L>T2*2̂(n*m)

T1/T2*2̂L>2̂(n*m)

1*2̂L>=T1/T2*2̂L>2̂(n*m)

2̂L>2̂(n*m)

2̂L>2̂(n*m)

(Since L>0, n>0, m>0) Log(2̂L)>Log(2̂(n*m))

L*Log(2)>n*m*Log(2)

L>n*m

L/n>m

For example, in the encryption methods in the present invention with an 8-bit random number sequence index, for KPA to be successful, it must find the key with fewer than 32 plaintext/ciphertext pairs, when the key length is 256 bit, and it must find the key with fewer than 7 plaintext/ciphertext pairs, when the key length is 56 bit.

In today's KPA attacks, the number of plaintext/ciphertext pairs is to be believed to be independent from computational complexity. However, the present invention is useful in that it can limit the number of needed plaintext/ciphertext pairs.

### Technically Advantageous Effects of the Present Invention

Encryption methods of the present invention are easy to implement combined with conventional encryption methods, while have a good coding ratio and do not need to scan plaintexts multiple times (easier to apply to streaming encryption). Moreover, even when the encryption key length cannot be increased, limited by standard compliance, by adding a method of the present invention, overall safety, especially safety against KPA can be improved.

1. A method for encrypting a text comprising:
generating a random number,
selecting, based on the random number, a random number sequence from a set of independent random number sequences with mutually different length,
transforming, based on the selected random number sequence, a first plaintext using a first transformation method,
concatenating the random number and the transformed first plaintext into a second plaintext, and
transforming the second plaintext using a second transformation method.

2. A method for encrypting a text according to claim 1 wherein:
the first transformation method comprises:
repeating the selected random number sequence, and
applying exclusive-OR operation on the repeated selected random number sequence and the first plaintext.

3. A computer program for encrypting a text comprising computer-executable instructions for:
generating a random number,
selecting, based on the random number, a random number sequence from a set of independent random number sequences with mutually different length,
transforming, based on the selected random number sequence, a first plaintext using first transformation instructions,
concatenating the random number and the transformed first plaintext into a second plaintext, and
transforming the second plaintext using second transformation instructions.

4. A computer program for encrypting a text according to claim 3 wherein:
the first transformation method comprises:
repeating the selected random number sequence, and
applying exclusive-OR operation on the repeated selected random number sequence and the first plaintext.

5. A computer system for encrypting a text comprising:
a generator of a random number,
a selector selecting, based on the random number, a random number sequence from a set of independent random number sequences with mutually different length,
a first transformer, based on the selected random number sequence, transforming a first plaintext using a first transformation method,
a concatenater concatenating the random number and the transformed first plaintext into a second plaintext, and
a second transformer, transforming the second plaintext using a second transformation method.

6. A computer system for encrypting a text according to claim 5 wherein:
the first transformer further comprises:
a third transformer, repeating the selected random number sequence, and
a fourth transformer, applying exclusive-OR operation on the repeated selected random number sequence and the first plaintext.
